(19) United States
(12) Patent Application Publication
(10) Pub. No.: US 2008/0169158 A1
(43) Pub. Date: Jul. 17, 2008

(54) Twin Screw Scissor Lift Assembly

(76) Inventor: Hong LAM, Thomhill (CA)

Correspondence Address: GOWAN INTELLECTUAL PROPERTY, 1075 NORTH SERVICE ROAD WEST, SUITE 203, OAKVILLE, ON, L6M-2G2, omitted

(21) Appl. No.: 11/623,444

(22) Filed: Jan. 16, 2007

(51) Int. Cl. B66F 7/14

(52) U.S. Cl. 187/211

(57) ABSTRACT

A scissor lift device is provided having twin vertical screws that act to raise or lower a substantially horizontal and flat platform using a pair of scissor jacks. A single DC motor can be provided within the scissor lift device housing, and is operatively connected to one vertical screw. The other vertical screw is connected to the first by a locked linkage that passes from one screw to the other in the base of the scissor lift device. As such, rotation of the motor results in an equal movement in both vertical screws, and thus equal movement of both scissor jacks. The configuration is easily serviced and installed, and is adapted to have the stationary and moveable components each covered by a protective shells. Additionally, the platform of the device can be easily leveled using a locking pin to lock the platform in a level position once the base of the device has been installed.

### FIELD OF THE INVENTION

The present invention relates generally to the field of vertical lifts, and in particular, to an improved lift mechanism for a scissor lift device.

### BACKGROUND OF THE INVENTION

Stairways employed in buildings and other structures present difficulties to non-ambulatory individuals. For example, a non-ambulatory individual confined to a personal vehicle such as a wheelchair cannot easily negotiate common stairwells. To accommodate such individuals, separate elevator lifts, moving chair arrangements, or ramps are often provided. In stair structures extending a vertical distance that is less than a building story, such as those typically used near the entrance to a building, a separate elevator lift is not always practical, particularly in outdoor environments. In such cases, separate ramps or moving chair arrangements may be provided which facilitate vertical travel by a personal vehicle.

One drawback to the use of a separate ramp to provide personal vehicle access to elevated surfaces is that suitable ramps consume relatively large amounts of space. As a result, existing buildings must often be substantially altered to accommodate the installation of a ramp. In many circumstances, space constraints within, or surrounding the building, make installation of a ramp impossible.

Moving chair arrangements offer a solution in such low rise environments. Moving chair arrangements comprise a chair that slides diagonally up and down the stairway. However, such arrangements require that the personal vehicle be separately transported up or down the stairway. Because personal vehicles can be quite heavy, separate transport of the personal vehicle can be difficult. Moreover, the movable chair itself, when not in use, still occupies stairway space and thus dictates the appearance of the staircase.

Separate vertical wheelchair lifts, which are termed in the industry as “vertical lifts” or more generally “lift assemblies”, have also been employed for such low rise environments for use in situations in which there is inadequate room for an access ramp. Such devices, are commonly used both for interior or exterior applications, and provide the ability to reversibly raise or lower an essentially flat, horizontal platform from a first position to a second position. An example of such a vertical lift is provided in U.S. Pat. No. 5,901,812 issued to Meunier.

Various motive forces can be utilized for raising or lowering the platform including hydraulic lifting systems, pneumatic lifting systems, scissor-jack lifting devices, or the like. A particularly common lifting motive force is an electric motor which uses one or two screw drives to operate a scissor lift assembly that supports the platform. A simple scissor lift assembly have a single screw is shown in U.S. Pat. No. 7,093,691 (Vaughan et al.), and a more complex twin screw lift assembly is shown in U.S. Pat. No. 6,109,395 (Storm) as part of a convertible lift assembly.

In these types of assemblies, an electric motor is used to rotate a horizontally positioned “screw” which passes through a threaded nut which is in engagement with a lower movable bracket on the scissor lift. As the screw is rotated by the motor, the nut is forced to move horizontally along the screw, either away from, or towards, a second lower bracket of the scissor lift, which second bracket can be either fixed or moveable. Regardless, however, as the scissor lift brackets move away or towards each other, upper brackets which are connected through a pivot point to the lower screw brackets, are also forced to move closer or away from one another, and, more importantly, forced to move up or down since the lower brackets are maintained at a set height.

In operation, a platform is connected to the upper brackets, and the platform is raised or lowered as the upper brackets move up and down.

Several problems can occur with this type of arrangement. Most notably, the electric motor is typically position at or near the screw position, and thus, is typically located underneath the platform assembly. As such, it is frequently inconvenient to access or service the motor. Also, the motor takes up space, and allowances for the motor must be made in installing the lift assembly, by either moving the lift away from the wall, or by providing a pit under the lift for the motor to rest in.

Further, when using multiple screws, it is important that operation of the two or more screws is synchronized so that they move at exactly the same rate and time. This is necessary so that the platform will remains level at all times as it moves up and down. Also, in a twin scissor lift assembly, the platform must also be easily leveled on site, so that an initial level position can be easily achieved.

While the prior art devices have demonstrated some utility in this area, there still continues to exist a need for a improved scissor lift assembly which provides better lifting performance than prior art scissor lift assemblies. Further, there continues to be a need for a twin screw scissor lift assembly wherein the platform of the lift can be easily leveled on-site, and the scissor lift assembly can be easily synchronized.

Still further, there continues to be a need for a scissor lift having improved safety features.

### SUMMARY OF THE INVENTION

Accordingly, it is a principal aspect of the present invention to provide a twin screw, scissor lift assembly that partially or fully meets the goals, needs and/or objectives set out hereinabove. These advantages, as well as other objects and goals inherent thereto, are at least partially or fully provided by the twin screw scissor lift assembly of the present invention, as set out hereinbelow.

In particular, the present invention fulfills the above needs, as well as others, by providing a twin screw scissor lift assembly which preferably provides a twin screw arrangement wherein both screws are powered by a single electric motor, and both have screw attachment mechanisms that permit the platform of the lift to be easily leveled, and which operate in a synchronized fashion. Further, the electric motor operating the twin screw lift assembly is preferably easily serviced.

Accordingly, in one embodiment, the present invention provides a twin screw scissor lift assembly comprising;

a support structure with a base for supporting said twin screw scissor lift assembly components;

a raisable, essentially flat horizontal platform which can be moved between a raised and a lowered position;

a pair of scissor jacks located on a first and second side of said lift assembly, each scissor jacket having a fixed lower bracket at one end of said base and a moveable lower bracket movable along said base, and each also having a fixed upper bracket indirectly attached to said raisable platform and a moveable upper bracket moveable along said raisable platform;

fixed, first and second rotatable, vertical screws located respectively on said first and second sides of said lift assembly;

connection brackets affixed to a said fixed upper brackets on each scissor jack, and thus also affixed to a first and second side of said raisable platform, and being threadably engaged with said first or second vertical screw so that rotation of said vertical screws causes said raisable platform to be raised or lowered on said scissor jacks;

a motive force, preferably located on one side of said lift assembly which motive force is operatively connected to said first vertical screw in order to reversably rotate said first vertical screw; and

connecting means, passing across the base of said support structure, which operatively connects said first vertical screw to said second vertical screw, whereby rotation of said first vertical screw causes a corresponding rotation of said second vertical screw.

The motive force is proved by a single motor which is preferably located within a housing on one side of the vertical lift, and which is essentially directly connected to the first vertical screw. The motive force is therefore also indirectly connected to the second, and any other vertical screw, by a connecting means which is preferably a locked linkage assembly passing across the base of the support structure, from one side of the vertical lift to the other. As such, the two or more vertical screws are linked together so that rotation of one effects a corresponding rotation of the others.

Moreover, the essentially direct connection between the motor and the first vertical screw is preferably also provided by a locked linkage assembly.

The locked linkage assembly is preferably provided by a toothed belt, a chain and sprocket or a fixed gear arrangement, or other such arrangement, wherein rotational movement of the motor output shaft results in an equal movement of all of the vertical screws. By avoiding the use of non-locked linkage assemblies, such as a plain flat belt, or a simple cross-sectional V-shaped belt, slippage of the screw drive systems, relative to one another, is minimized and/or avoided. Moreover, as a result, a synchronized movement of the vertical screws is ensured.

The number of rotating vertical screws is typically between 2 to 4 screws. However, typically, only 2 screws are needed, and thus provide a twin screw arrangement.

Also, while the screws are termed herein as being “fixed”, this is to be understood to mean that the screws do not move in location within the lift assembly. They merely rotate within a set position, and thus, they force an operatively connected threaded “nut” on the connection bracket, which causes the connection bracket to travel up or down depending on the direction of screw rotation.

The scissor jacks preferably comprise: two lower brackets, one of which is fixed in position, and the other of which is free to move along a base member located on said first and second sides of said lift assembly; and two upper brackets, one of which is fixed in position, and the other of which is free to move along the underside of an upper frame member connected to said first and second sides of said platform.

The raisable platform can be merely a single flat platform on which the user is positioned. However, the platform can also be formed as being part of a movable shell which covers the sides of the lift assembly, as will be described hereinbelow.

### BRIEF DESCRIPTION OF THE DRAWINGS

Embodiments of this invention will now be described by way of example only in association with the accompanying drawings in which:

FIG. 1 is a perspective view of the scissor lift assembly of the present invention, which is shown with a twin screw arrangement

FIG. 2 is a side view of a first side of the embodiment of FIG. 1 in a raised position;

FIG. 3 is a. side view of the second side of the embodiment of FIG. 1 in a collapsed position;

FIG. 4 is a top view of the base of the embodiment of FIG. 1;

FIG. 5 is a side view of the first side, with optional batteries added;

FIG. 6 is a perspective view of a further embodiment of the present invention;

FIG. 7 is a side view of the embodiment of FIG. 6;

FIG. 8 is a perspective view of the embodiment of FIG. 6 and including protective panels; and

FIG. 9 is a cross-sectional view of the pin leveling system of the present invention.

### DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example only. In the drawings, like reference numerals depict like elements.

It is expressly understood, however, that the drawings are for the purpose of illustration and description only and are not intended as a definition of the limits of the invention.

Also, while a plurality of vertical screws can be used in the practice of the present invention, in a preferred arrangement, two screws are used in the embodiment shown herein in a “twin screw” arrangement. For brevity the remaining discussion will address only a twin screw arrangement, but those skilled in the art will appreciate that additional vertical screws might also be used.

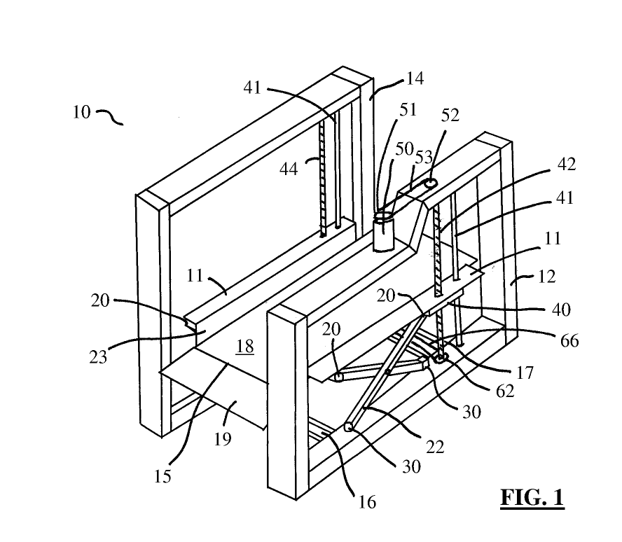

Referring to FIGS. 1 to 4, a twin screw scissor lift 10 is shown having a support structure consisting of a first side structure 12, a second side structure 14, a first cross member 16 and a second cross member 17. Each of sides 12 and 14, holds a scissor jack 22 or 24. Resting on top of scissor jacks 22 and 24 are platform supports 11 which supports are attached to a platform 18. Lower brackets 30 of jacks 22 and 24 are positioned on the lower frame members 32 and 34 of sides 12 and 14. Connecting brackets 40 are provided on scissor jacks 22 and 24 to connect supports 11, and thus platform 18, to one of the upper brackets 20 of scissor jacks 22 and 24.

Scissor jacks 22 and 24 are essentially the same as the commonly available scissor jacks known and used in the art. As such, in general they operate in a known fashion. However, in the present invention, the scissor jacks are preferably located within side structures 12 and 14 so as to be easily covered by a shell, as described hereinbelow.

One lower bracket of each scissor jack is essentially fixed in place on the base of lift 10. A second lower bracket moves (by sliding or rolling) along the base of lift 10. One upper bracket is fixed to connection bracket 40, and/or alternatively, directly to platform 18. A second upper bracket is free to move (by sliding or rolling) along the underside of support 11 and/or platform 18. The design and selection of appropriate scissor jacks is known to those skilled in the art.

Connecting brackets 40 are also connected to threaded vertical screws 42 and 44 using a threaded “nut” which nut corresponds to the threads of screws 42 and 44. Since screws 42 and 44 are fixed in place, rotation of screws 42 and 44 causes connection brackets 40 to move up or down depending on the direction of rotation of vertical screws 42 and 44. Brackets 40 are connected to supports 11, and thus also affixed to platform 18 (and/or an upper fixed bracket of scissor jacks 22 and 24), so that movement of brackets 40 causes platform 18 to be raised or lowered.

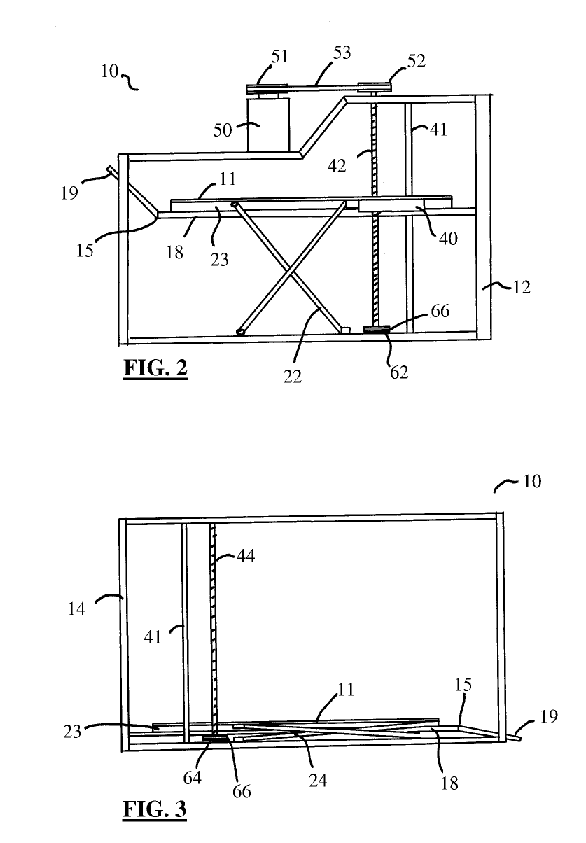

Platform 18 is essentially flat in its interior portion, but is shown as having raised sides 23 when connecting to supports 11. This allows, platform 18 to be nearer to the ground when scissor jacks 22 and 24 are in a fully collapsed position. Also, the front end of platform 18 preferably has a hinge 15 with a moveable section 19, which can also be raised to the position shown in FIG. 2, wherein it acts as a barrier to movement of a wheelchair off of platform 18. This can be done when platform 18 is off the ground, such as either when being raised, or when left in a raised position. Moveable section 19 can also be lowered to a position wherein a leading edge 13 is adjacent to the ground, as shown in outline in FIG. 3, in order to facilitate entry of the user on to platform 18. Movement of section 19 can be accomplished in a manner known within this art, and will not be described in any further detail.

A single electric motor 50, which acts as the motive force for this assembly, hangs from side 12, and is essentially directly connected by a toothed belt 53 to the upper end of vertical screw 12. A toothed pulley 51 is attached to motor 50, and a second toothed pulley 52 (connected through belt 52) is attached to vertical screw 42.

At the opposite, lower end of vertical screw 42, a toothed pulley 62 is positioned which is connected to a corresponding toothed pulley 64 on the lower end of vertical screw 44. Pulleys 62 and 64 are also connected using a toothed belt 66 which acts as a locked linkage assembly, and which passes across the support structure by passing through cross member 18. Cross member 18 is essentially hollow and is sized so as to receive belt 66. Optionally, guide pulleys 70, or alternatively belt tensioning devices, might also be positioned within cross member 18 in order to keep belt 66 in the proper position.

It is to be noted that the combination of a toothed belt 66 and corresponding toothed pulleys 62 and 64 is the preferred method for establishing a locked linkage between the components, and in particular, the linkage between pulleys 62 and 64. This linkage provides the locked linkage necessary for the correct operation of the present invention. However, other methods of providing a locked linkage might be used including, for example, a chain and sprocket combination, a direct gear arrangement, or the like.

A locked linkage between motor 50 and pulley 52 is not essential, but is preferred in order to minimize slippage of belt 53.

Each of sides 12 and 14 are also provided with optional support rods 41 which are provided adjacent and essentially parallel to, vertical screws 42 and 44. Preferably, connecting brackets 40 extend from vertical screws 42 and 44 and have an opening through which support rods 41 can pass. With support rods 41 in place, any tendency for connecting brackets 40 to rotate with screws 42 or 44 is reduced and/or prevented. As such, while optional support rods 41 can be eliminated, they are preferably used to strengthen the structure of the connecting bracket assembly.

For improved clarity, in FIG. 4, details of lift 10 are shown wherein scissor jacks 22 and 24, and platform 18 have been removed. The details of the structure of lift 10 can thus be more clearly seen.

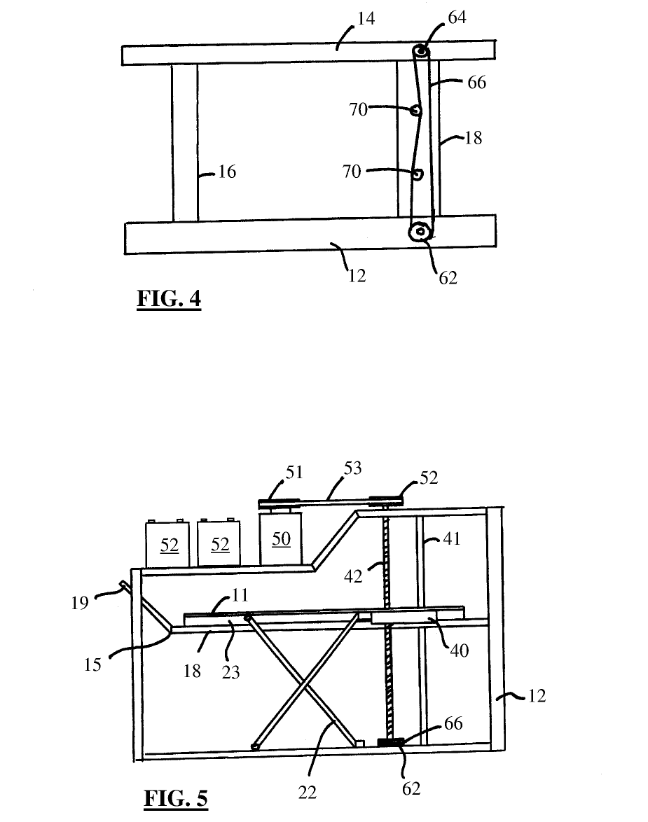

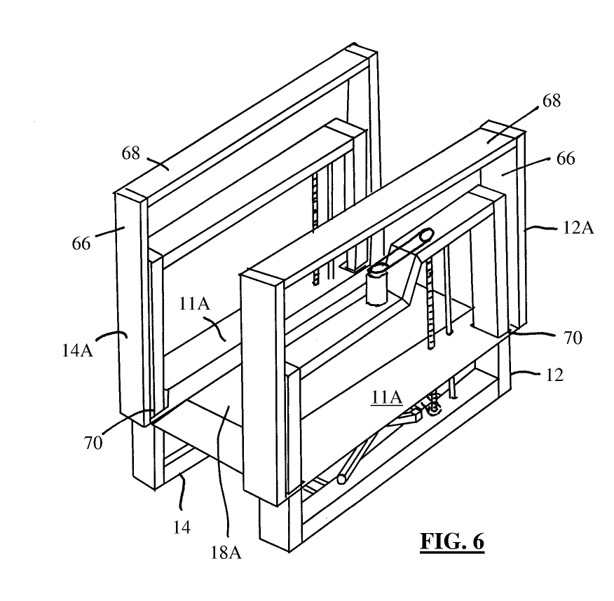

Also, it is noted that motor 50 can be any suitable electric motor which can be controlled by a control panel fitted within lift 10. Motor 50 can be an AC motor operating at any locally acceptable voltages and frequencies. Alternatively, motor 50 might be a DC motor, again operating at any suitable voltage. In this preferred embodiment of the invention, lift assembly 10 can incorporate rechargeable DC batteries 52 into side structure 12, for example, as shown in FIG. 5. Use of a DC motor 50 and rechargeable DC batteries 52 permits lift 10 to continue to operate even in the event of a loss of electrical power to lift 10. This ensures that the user will be able to complete the transfer to a different floor level regardless of the loss of power, or to allow emergency use of the lift in the event of a power failure.

To incorporate motor 50 and optional batteries 52, it is noted that at least side 12 is typically larger than normally used in a lift assembly. This permits these components to be housed within side 12 section, and thus permits easy access to these components for servicing or the like.

In FIG. 6, a variation of an embodiment of the present invention is provided wherein side structures 12 and 14 form a support for an inner shell cover 60 (FIG. 8). An outer shell cover 62 (FIG. 8) can be attached, and extends over and upper, moveable side structures 12A and 14A which are connected to platform 18A and/or platform supports 11A. As such, side structures 12A and 14A, as well as outer shell 62 are raised and lowered as platform 18A moves up and down.

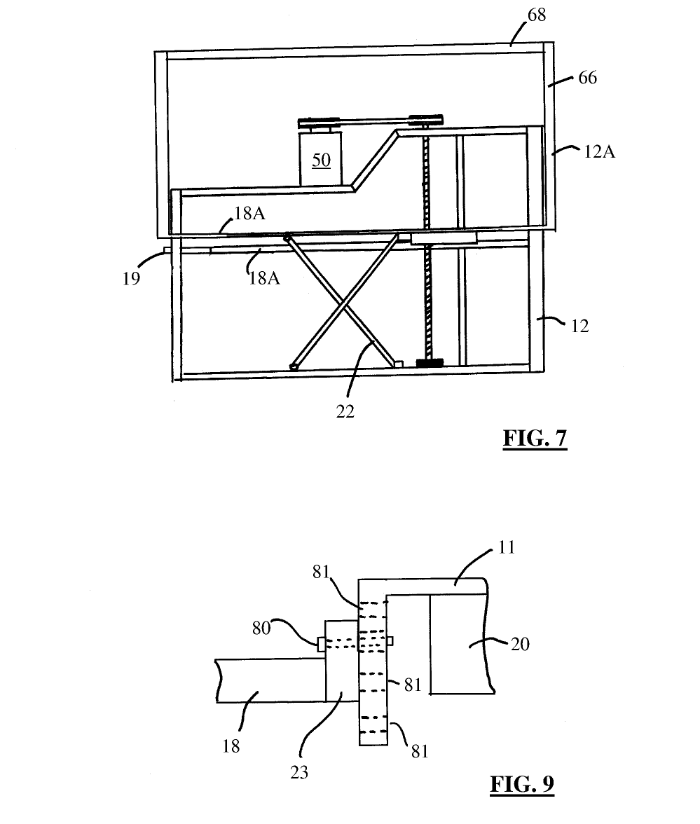

Platform 18A can be directly connected to sides 12A and 14A. However, platform 18A is preferably connected to sides 12A and 14A using platform supports 11A. Side sections 12A and 14A therefore have modified supports 11A, similar to supports 11, as well as moveable side supports 66 and top supports 68. Openings 70 are provided in supports 11A in order to allow portions of side supports for side sections 12 and 14 to pass through supports 11A as platform 18A is raised and lowered. A side view of this arrangement can be seen in FIG. 7.

A further advantage of the embodiment of FIG. 6 is that the inner and outer shells can be covered in a protective material, such as for example, sheet metal, plastics, wood panels or the like, and that these protective panels can be provided to enhance safety by preventing unintended access to the scissor lift components. This can be seen in FIG. 8, wherein protective coverings have been placed as inner shell 60, and outer shell 62, respectively.

Inner shell 60 preferably covers said base, scissor jacks and at least a lower section of the side sections. Outer shell 62 is preferably affixed to said platform so as to move with said platform, and further, preferably covers at least an upper portion of said side section. As such, outer shell 62 moves up and down over inner shell 60.

As a consequence of adding shells 60 and 62, and outer shell 62, in particular, while the user is riding up or down on platform 18A, it is virtually impossible for the user to reach any moving parts. Further, shells 60 and 62 are preferably made of a smooth material, and therefore, the possibility of injury on a sharp corner, or the like, is reduced. However, these covers can be easily removed for servicing.

Accordingly, in a further embodiment, an improved scissor lift assembly is provided having the components hereinabove described, together with inner and outer protective shells around said assembly, wherein said inner shell covers said base, scissor jacks and at least a lower section of said side sections, and said outer shell is affixed to said platform so as to move with said platform, and covers at least an upper portion of said side section.

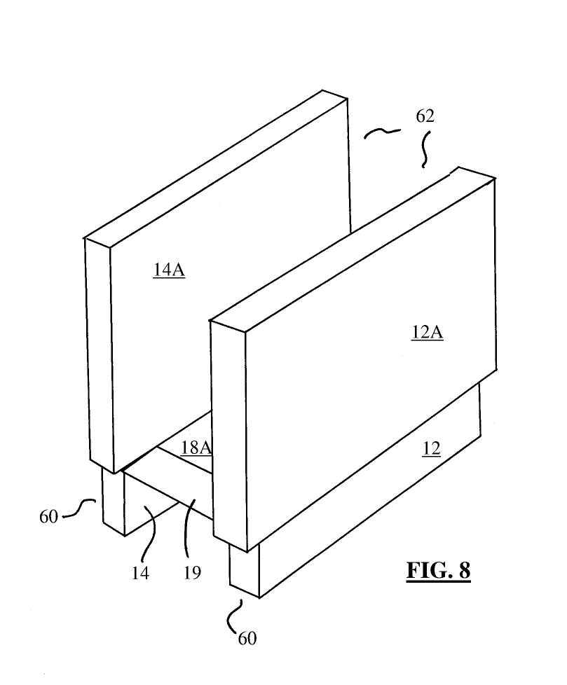

A further advantage of the scissor lift of the present invention is that the platform can be more easily leveled. In prior art applications, it is necessary to level the base structure for the lift in order to ensure that the platform was essentially level. In a preferred embodiment of the present invention, as seen in FIG. 9, sides 23 of platform 18 are provided with connecting holes through which leveling pins 80 can be inserted at various locations. Pins 80 pass through side 23, and are inserted into any one of a series of leveling holes 81 on support 11, which act as leveling braces. In operation, the base of lift 10 of the present invention is positioned in a desired location. Once the base is in position, platform 18 is moved to a level position where one side is locked into position, and the other side is level to the first. At that time, pins 80 are inserted through sides 23 and into a suitable and corresponding openings 81 on supports 11 (or 11A) in order to lock platform 18 in a level orientation. Pins 80 can be provided at the four corners of platform 18, although any suitable variation on the number and location of the pins can be used.

Once platform 18 has been leveled, inner and outer shells 60 and 62 can be put in position.

As a result, the two scissor jacks 22 and 24 do not need to be perfectly coordinated and at the same height in order to setup the lift of the present invention. Instead the scissor jacks can be positioned roughly in place, and the final leveling of platform 18 can be done using pins 80 and supports 11 or 11A.

As such, an improved scissor lift assembly has been provided. Thus, in a still further preferred embodiment, the present invention also preferably provides a twin screw scissor lift assembly as described hereinabove, wherein said platform comprises an essentially flat, horizontal section affixed to vertical side sections, and wherein said connection brackets are affixed to a leveling brace within each side section, and wherein said vertical side section has at least one connecting holes through which a leveling pin can be inserted, and said leveling brace has a series of holes that can be selected for receiving said pin, once said platform has been leveled.

Further, in general, it is also to be noted that lift 10 might also comprise a series of barrier plates or railings for the protection of the user. However, these have been omitted from the Figures of the present application, in order to improve the brevity and clarity of the figures. The skilled artisan would be well aware of their use and utility in the practice of the present invention. Additionally, for brevity, the user operational control panels have not been shown, but the skilled artisan would be well aware of their placement and use.

Moreover, the scissor lift of the present invention can be produced as a small self-contained unit, self-contained unit with lower weight, and smaller size than prior art scissor lift assemblies. As such, lifts of the present invention will typically weigh less than 300 kg, and more preferably less than 250 kg. It is to be further noted, that the scissor lift assembly of the present invention is preferably fabricated to provide movement of the platform which will be roughly equivalent to 2 to 6 stairs, and more preferably 3 to 5 stairs. A typical embodiment will have a platform movement of about the height of 4 stairs. As such, the total vertical platform movement of the lift of the present invention is preferably less than 1.5 meters, and more preferably, less than 1.1 meters. However, other heights may be utilized.

Thus, it is apparent that there has been provided, in accordance with the present invention, a scissor lift assembly which fully satisfies the goals, objects, and advantages set forth hereinbefore. Therefore, having described specific embodiments of the present invention, it will be understood that alternatives, modifications and variations thereof may be suggested to those skilled in the art, and that it is intended that the present specification embrace all such alternatives, modifications and variations as fall within the scope of the appended claims.

Additionally, for clarity and unless otherwise stated, the word “comprise” and variations of the word such as “comprising” and “comprises”, when used in the description and claims of the present specification, is not intended to exclude other additives, components, integers or steps.

Moreover, the words “substantially” or “essentially”, when used with an adjective or adverb is intended to enhance the scope of the particular characteristic; e.g., “substantially planar”, or “essentially planar” is intended to mean planar, nearly planar and/or exhibiting characteristics associated with a planar element.

Also, while this discussion has addressed prior art known to the inventor, it is not an admission that all art discussed is citable against the present application.

We claim:

1. A twin screw scissor lift assembly comprising:
a support structure with a base for supporting said twin screw scissor lift assembly components;
a raisable, essentially flat horizontal platform which can be moved between a raised and a lowered position;
a pair of scissor jacks located on a first and second side of said lift assembly, each scissor jacket having a fixed lower bracket at one end of said base and a moveable lower bracket movable along said base, and each also having a fixed upper bracket indirectly attached to said raisable platform and a moveable upper bracket moveable along said raisable platform;
fixed, first and second rotatable, vertical screws located respectively on said first and second sides of said lift assembly;
connection brackets affixed to a said fixed upper brackets on each scissor jack, and thus also affixed to a first and second side of said raisable platform, and being threadably engaged with said first or second vertical screw so that rotation of said vertical screws causes said raisable platform to be raised or lowered on said scissor jacks;
a motive force operatively connected to said first vertical screw in order to reversably rotate said first vertical screw; and
connecting means, passing across the base of said support structure, which operatively connects said first vertical screw to said second vertical screw, whereby rotation of said first vertical screw causes a corresponding rotation of said second vertical screw.

2. A twin screw scissor lift assembly as claimed in claim 1 wherein said motive force is proved by a single motor.

3. A twin screw scissor lift assembly as claimed in claim 2 wherein said single motor is located within a housing on one side of the vertical lift and is essentially directly connected to said first vertical screw.

4. A twin screw scissor lift assembly as claimed in claim 3 wherein said first vertical screw is connected to said second vertical screw, and optionally additionally to said motor, by a locked linkage assembly.

5. A twin screw scissor lift assembly as claimed in claim 4 wherein said locked linkage assembly is provided by a toothed belt, a chain and sprocket or a fixed gear arrangement.

6. A twin screw scissor lift assembly as claimed in claim 1 wherein each of said scissor jacks comprises:
two lower brackets, one of which is fixed in position, and the other is free to move along a base member located on said first and second sides of said lift assembly; and
two upper brackets, one of which is fixed in position, and the other is free to move along an upper frame member connected to said first and second sides of said platform.

7. A twin screw scissor lift assembly as claimed in claim 1 wherein said connecting brackets are connected to said platform through platform supports.

8. A twin screw scissor lift assembly as claimed in claim 1 additionally comprising guide pulleys or belt tensioning devices acting on said connecting means.

9. A twin screw scissor lift assembly as claimed in claim 1 additionally comprising support rods, essentially parallel to said vertical screws, and wherein said connecting brackets have openings through which said support rods can pass as said connecting bracket moves up and down on said vertical screw, wherein said support rods prevent rotation of said connecting bracket around said vertical screw.

10. A twin screw scissor lift assembly as claimed in claim 2 wherein said motor is a DC motor, and said lift assembly further comprises batteries for powering said DC motor.

11. A twin screw scissor lift assembly as claimed in claim 1 additionally comprising inner and outer protective shells around said assembly, wherein said inner shell covers said base, scissor jacks and at least a lower section of said side sections, and said outer shell is affixed to said platform so as to move with said platform, and covers at least an upper portion of said side section.

12. A twin screw scissor lift assembly as claimed in claim 1 wherein said platform comprises an essentially flat, horizontal section affixed to vertical side sections, and wherein said connection brackets are affixed to a leveling brace within each side section, and wherein said vertical side section has at least one connecting holes through which a leveling pin can be inserted, and said leveling brace has a series of holes that can be selected for receiving said pin, once said platform has been leveled.
